(19) United States
(12) Patent Application Publication
(10) Pub. No.: US 2006/0043632 A1
(43) Pub. Date: Mar. 2, 2006

(54) Process for manufacturing thermoplastic components for golf balls

(76) Inventor: Keith C. Andersen, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/211,200

(22) Filed: Aug. 25, 2005

Related U.S. Application Data
(60) Provisional application No. 60/604,332, filed on Aug. 25, 2004.

(51) Int. Cl. B29C 45/14; B29C 37/00; B29B 7/00; B29C 45/00

(52) U.S. Cl. 264/161; 264/278; 264/328.14; 264/328.9; 264/328.11; 264/328.16

(57) ABSTRACT

The present invention describes an injection molding process for manufacturing golf balls using thermoplastic materials. The injection mold is provided with a heating source and one or more valve gates. The heating source maintains the temperature of the molten thermoplastic material in the conduits through which it is delivered to the mold cavity, and the valve gate shuts off the flow of molten thermoplastic material to the mold cavity. Advantageously, this process reduces or eliminates “trim” or waste material, and thus also minimizes the necessity to recycle thermoplastic material.

This application claims the benefit of U.S. Provisional Application No. 60/604,332, filed Aug. 25, 2004, which is incorporated herein in its entirety.

### FIELD OF THE INVENTION

The present invention relates to a process for manufacturing golf balls. Particularly, the present invention relates to a process for molding golf balls having a thermoplastic center or core, or one or more thermoplastic layers.

### BACKGROUND OF THE INVENTION

Several patents and publications are cited in this description in order to more fully describe the state of the art to which this invention pertains. The entire disclosure of each of these patents and publications is incorporated by reference herein.

There currently exist several types of premium golf balls, particularly three-piece balls, two-piece balls and multi-layered balls. “Three-piece” balls typically have a spherical molded center, having an elastomeric thread-like material wound around it, covered with either a thermoplastic or thermoset material. “Two-piece” balls typically have a spherical molded core covered with a thermoplastic material. “Multi-layered” balls typically have a core and one or more intermediate layers (or mantles) between the core and a cover.

The material used to mold the three-piece centers and the two-piece and multi-layer cores has traditionally been a thermoset rubber such as polybutadiene rubber, cross-linked EVA, cross-linked SBS, and cross-linked urethanes. Thermoset materials have generally been used in applications such as these, where resilience, durability, and low hardness are desirable properties.

The injection molding processes used to produce golf balls and portions of golf balls typically result in a substantial portion of waste or “trim.” For example, the material that solidifies in the mold's “runners,” the conduits that carry molten polymer to the mold cavity, must be trimmed away from the ball or partially complete ball. Clearly, it is economically and environmentally desirable to recycle the trimmed material by combining it with virgin material to produce new golf balls or golf ball parts. There are disadvantages in using thermoset rubbers as recycle materials, however, because the recycled material can cause a loss of critical properties in a finished golf ball.

Although conventional golf ball manufacturers generally do not utilize thermoplastic materials in cores, there has been some limited success in replacing thermoset materials in golf balls with thermoplastic materials, which are more easily processed, and the scrap of which can generally be recycled. For example, limited flight range balls have been produced from thermoset rubber and from certain thermoplastic material as set forth in U.S. Pat. No. 5,155,157, wherein the balls comprise blends of copolyetheresters or copolyetheramides, and an epoxy-containing compound with ethylene copolymer ionomer.

U.K. Patent Application 2,164,342A describes moldable compositions comprising ionic copolymers blended with certain thermoplastic materials such as a polyether block copolyamide, polyether block copolyester and the like to produce a one-piece golf ball by injection molding.

U.S. application Ser. No. 09/422,122 (filed Oct. 21, 1999), and the patent applications that claim priority to it, describe thermoplastic ethylene acid copolymer ionomer compositions that can be molded by injection or compression molding for use as golf ball cores, covers, and/or mantles.

While previous references note that injection molding can be used to form thermoplastic cores and layers, none of the prior art references fully describes an injection molding process using thermoplastic materials. Moreover, certain thermoplastic materials present handling difficulties, such as hygroscopic properties. Recycling the trim or ground excess (“regrind”) of a hygroscopic thermoplastic material, for example certain ionomers, back into the process can be undesirable due to the moisture sensitivity of the resin. Trim that has picked up undesirable levels of moisture can have deleterious effects on the properties of golf ball parts molded therefrom. Because recycling thermoplastic trim material can be problematic, it is typically avoided. Materials used in covers are generally less hygroscopic, and therefore including regrind is less problematic. However, molding golf balls using conventional methods can produce substantial amounts of polymer trim, and can represent a substantial loss of raw material if the trim is not re-introduced into the process. This has been a major factor in preventing the use of ionomers as a material for use in golf balls, particularly as thermoplastic core materials. For example, the amount of waste material can be greater than 15% by weight of a core, and up to as much as 50% by weight of a core when using conventional golf ball runner core molds.

It is therefore desirable to have an improved process for molding golf ball cores and layers from thermoplastic materials that reduces or eliminates the amount of polymer trim produced in a golf ball manufacturing process.

### SUMMARY OF THE INVENTION

In one aspect, the present invention is an injection molding process for forming a thermoplastic golf ball core wherein excess polymer trimmed from the molded core (polymer trim) is less than 15% by weight of the weight of the manufactured core.

In another aspect, the invention provides an injection molding apparatus for overmolding a layer on a portion of a golf ball, and a method of molding a golf ball or golf ball part using the apparatus of the invention.

In another aspect, the present invention is an injection molding process for forming a thermoplastic golf ball, the process comprising the step of: heating a thermoplastic material to a temperature above its melting point, and maintaining said temperature in the thermoplastic material until it is delivered to a golf ball mold, and deposited into the mold.

In still another aspect, the present invention is an injection molding process for forming a thermoplastic golf ball comprising an ethylene acid copolymer ionomer, the process comprising the step of: injection molding an ethylene acid copolymer ionomer composition into a golf ball mold at a temperature of at least about 405° F. to about 550° F., wherein the conduit through which the ionomer is transported to the mold comprises an external heat source to maintain the ionomer at a temperature of at least about 405° F. to about 550° F.

In still another aspect, golf balls obtainable from the processes of the invention are provided.

### DETAILED DESCRIPTION OF THE INVENTION

The definitions herein apply to the terms as used throughout this specification, unless otherwise limited in specific instances.

“Polymer trim” as the term is used herein describes excess thermoplastic resin that: (1) has been melted or softened sufficiently to be injected through a die and transported through a conduit to a golf ball mold; (2) has not entered into the mold, but nonetheless has the same heat history as the molded material; (3) must be cut or removed by some means from the molded core or layer in order to obtain a usable molded ball or portion of a ball.

The term “(meth)acrylic”, as used herein, alone or in derivative form, means “acrylic, methacrylic, or a mixture of acrylic and methacrylic”. For example, “alkyl (meth)acrylate” as used herein refers to alkyl acrylate, alkyl methacrylate, or to a mixture of alkyl acrylate and alkyl methacrylate.

The terms “finite amount” and “finite value” refer to an amount that is not equal to zero.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In one embodiment, the present invention is a process for molding a golf ball core or layer by injection of a thermoplastic polymer into a mold. This improved process for molding thermoplastic golf balls and portions of golf balls is suitable for large scale manufacture. The process of the present invention reduces, minimizes, or essentially eliminates in a molding process the production of polymer trim around a molded core or layer. For example, in the practice of the present invention, the polymer trim is reduced to less than about 15% by weight of the weight of the thermoplastic core. Preferably, the weight of the polymer trim is less than about 10 wt % of the thermoplastic core, and more preferably less than about 5 wt % of the thermoplastic core. In a particularly preferred embodiment, the polymer trim produced using the process of the present invention is less than 1 wt % of the manufactured thermoplastic polymer core. Most preferred is complete elimination of the excess polymer trim in a golf ball core/mantle.

An injection mold includes a manifold or body. The mold also includes one or more cavities that are shaped according to the size of core, ball, or portion of a ball that is desired. The molten material is carried through the manifold to the mold cavity via runners or channels that have openings or inlets into the cavity. The cavity can be cooled by a cooling means, such as a water jacket for example, so that the mold cavity is held at a temperature that is significantly lower than the melting point or processing temperature of the thermoplastic material. Because golf balls are spherical, the injection molds typically have two symmetrical halves, each of which includes a hemispherical mold cavity. The mold halves separate along a parting line. The position of the parting line is sometimes referred to as the “equator” of the ball or part. The “north and south poles” then designate those points on the ball or part that are furthest from the plane that transects the parting line or equator.

An injection mold useful in a process of the present invention includes one or more valve gates to shut off the flow of polymer to the mold cavity. A valve gate typically includes a pin that blocks the flow of polymer into the mold cavity. Placing the valve gate as close as possible to the mold cavity will minimize polymer trim by shortening the length of the runner that remains attached to the part after molding. The elimination of the alternative thermal gates also reduces the risk of forming unacceptable voids in the molded part.

In a process of the present invention, molten thermoplastic polymer is delivered to the mold cavity through runners or channels that are radius flow channels. Radius flow channels promote laminar flow and thus avoid turbulence, including dead spots or high-shear sharp corners in the flow path of the polymer. Turbulent flow is undesirable because it may produce “hot spots” where the molten polymer dwells for a longer time. The uniformity of the polymer's heat history is important for maintaining consistent and optimal properties in the finished golf ball, particularly when the thermoplastic material is hygroscopic. Preferably, the flow channels are sized and shaped such that the shear experienced by the thermoplastic material is less than or equal to 1000 sec⁻¹. Those of skill in the art are aware that the viscosity and flow rate or pressure of the molten material also affect the shear rate.

Preferably, in a process of the present invention, the temperature of the manifold and the polymer flow channels are controlled to within 20° F. of the process temperature used for the thermoplastic polymer. Also preferably, the manifold and polymer flow channels are heated using heaters. More preferably, the heaters are positioned such that they do not cross over the polymer flow channels. In this way, hot spots are still further avoided. With the use of valve gates and a heated manifold and/or heated runners, the molten thermoplastic material can remain molten until it is used to fill the mold, while material in the mold cavity cools to form the solid molded ball or portion of a ball.

When the process of the invention is used to form a spherical golf ball core, it is sufficient to provide only one half of the mold with valve gates and a heated manifold and/or heated runners. This is because the inlets of the runners are typically located along the equator of the mold cavity. Generally, the half of the mold including the heaters is fixed, and the other half of the mold is removable to eject the finished parts.

Certain adaptations facilitate the use of the process to overmold a sphere with a thermoplastic material to form an intermediate layer or mantle, or to form a cover. For example, a sphere to be overmolded is usually held in place in the cavity by means of pins that extend into the mold from the direction of the north and south poles. So that the center point of the core or center is as close as possible to the center point of the overmolded core or center, the polymer flow into the mold should not displace the sphere from the pins. In order to accomplish this, the inlets of the runners are typically also located at or near the north and south poles of the mold cavity. Thus, both halves of the mold require valve gates and a heated manifold and/or heated runners. In addition, an overmolding process of the invention is facilitated by providing the mold with a heated passage between its two halves. The purpose of the heated passage is to maintain the temperature of the molten thermoplastic material, preferably within 20° F. of its processing temperature, as it passes from the channels of one half of the mold to the channels of the other half of the mold. The heated passage is preferably flexible for convenience, so that it does not need to be detached from the mold or disassembled when the halves of the mold are separated to remove the overmolded balls or parts. Flexible heated passages are commercially available.

Thermoplastic materials that are useful in golf balls preferably have a weight average molecular weight ranging from about 80 kD to about 500 kD. Suitable thermoplastic materials include, without limitation, polyurethanes; polyureas; poly-ether-esters; poly-amide-ethers; polyether-ureas; PEBAX™ block copolymers based on polyether-block-amide, available from Atofina Chemicals, Inc., of Philadelphia, Pa.; styrene-butadiene-styrene (SBS) block copolymers, styrene(ethylene-butylene)-styrene block copolymers, etc.; EPDM; polyamides (oligomeric and polymeric); polyesters; polyolefins including HDPE, LDPE, LLDPE, PP, E/P copolymers, etc.; ethylene copolymers with various comonomers, such as vinyl acetate, alkyl (meth)acrylates, alkyl (meth)acrylic acid, epoxy-functionalized monomer, CO, maleic acid, maleic ester, maleic anhydride, (meth)acrylonitrile, etc.; functionalized polymers with maleic anhydride, epoxy functionality, etc., either by copolymerization or by grafting; metallocene catalyzed PE, PP and ethylene copolymers; ground up powders of the thermoset elastomers; polystyrene and copolymers; and the like, these classes of polymers being well known in the art.

Preferred thermoplastic resins include copolyetheresters, copolyetheramides, elastomeric polyolefins, styrene diene block copolymers, polyurethanes, polyamides, polyesters, polyolefins, ethylene copolymers, anhydride modified ethylene or propylene homopolymers and copolymers, mPE, and the like.

Certain thermoplastic resins may be further characterized as elastomers. The term “elastomers”, as used herein, refers to polymers having one or more elastomeric features. The term “elastomeric features”, as used herein, refers to the property of a material of recovering, in whole or in part, one or more of its original dimensions upon removal of a deforming force and continuing to exert a force to recover one or more of its original dimensions if complete recovery is prevented by an opposing force.

Examples of suitable thermoplastic resins that may also be characterized as elastomers include, for example, poly-ether-esters, poly-amide-ethers, polyether-ureas, PEBAX™ block copolymers, elastomeric polyolefins, styrene-butadiene-styrene (SBS) block copolymers, styrene(ethylene-butylene)-styrene block copolymers, and the like.

Preferred thermoplastic elastomers include copolyetheresters, copolyetheramides, elastomeric polyolefins, styrene diene block copolymers and thermoplastic polyurethanes. The copolyetheresters are discussed in detail in U.S. Pat. Nos. 3,651,014; 3,766,146; and 3,763,109, inter alia. The preferred copolyetherester polymers are those wherein the polyether segment is obtained by polymerization of tetrahydrofuran and the polyester segment is obtained by polymerization of tetramethylene glycol and phthalic acid. The more polyether units incorporated into the copolyetherester, the softer the polymer.

The copolyetheramides are also well known in the art as described in U.S. Pat. No. 4,331,786, for example. They are comprised of a linear and regular chain of rigid polyamide segments and flexible polyether segments.

The elastomeric polyolefins are polymers composed of ethylene and higher primary olefins such as propylene, hexene, octene and optionally 1,4-hexadiene and or ethylidene norbornene or norbornadiene. The elastomeric polyolefins can be functionalized with maleic anhydride.

Thermoplastic polyurethanes are linear or slightly chain branched polymers consisting of hard blocks and soft elastomeric blocks. They are produced by reacting soft hydroxy terminated elastomeric polyethers or polyesters with diisocyanates such as methylene diisocyanate (MDI) or toluene diisocyanate (TDI). These polymers can be chain extended with glycols, diamines, diacids, or amino alcohols. The reaction products of the isocyanates and the alcohols are called urethanes and these blocks are relatively hard and high melting. These hard high melting blocks are responsible for the thermoplastic nature of the polyurethanes.

Block styrene diene copolymers are composed of polystyrene units and polydiene units. The polydiene units are derived from polybutadiene, polyisoprene units or copolymers of these two. In the case of the copolymer it is possible to hydrogenate the polyolefin to give saturated rubbery backbone segments. These materials are usually referred to as SBS, SIS or SEBS thermoplastic elastomers and they can also be functionalized with maleic anhydride. Ionomers are preferred thermoplastic materials for use in the processes of the invention. Particularly preferred are ionomers of alpha olefin, particularly ethylene, C₃₋₈ α,β-ethylenically unsaturated carboxylic acid, particularly (meth)acrylic acid, copolymers. The acid copolymers are preferably “direct” acid copolymers, rather than acid-grafted copolymers, wherein an acid monomer is reacted with or “grafted onto” an already-formed polymer. They may optionally contain a third, softening monomer. By “softening”, it is meant that the crystallinity is disrupted (the polymer is made less crystalline). Suitable “softening” comonomers are monomers selected from alkyl (meth)acrylates, wherein the alkyl groups have from 1-8 carbon atoms.

The acid copolymers, when the alpha olefin is ethylene, can be described as E/X/Y copolymers where E is ethylene, X is the α,β-ethylenically unsaturated carboxylic acid, and Y is a softening comonomer. X is preferably present in about 3 to about 30 (preferably about 4 to about 25, more preferably about 5 to about 20) wt % of the polymer, and Y is preferably present in a finite amount up to 30 (alternatively about 3 to about 25 or about 10 to about 23) wt % of the polymer.

The ethylene-acid copolymers with high levels of acid (X) are difficult to prepare in continuous polymerizers because of monomer-polymer phase separation. This difficulty can be avoided however by use of “co-solvent technology” as described in U.S. Pat. No. 5,028,674 or by employing somewhat higher pressures than those at which copolymers with lower acid can be prepared.

Preferred acid copolymers include ethylene/(meth)acrylic acid copolymers. They also include ethylene/(meth)acrylic acid/n-butyl(meth)acrylate, ethylene/(meth)acrylic acid/iso-butyl (meth)acrylate, ethylene/(meth)acrylic acid/methyl(meth)acrylate, and ethylene/(meth)acrylic acid/ethyl(meth)acrylate terpolymers.

The E/X/Y copolymers may be neutralized to any level that does not result in an intractable (not melt processible) polymer that does not have useful physical properties. Preferably, about 15 to about 80%, and more preferably about 50 to about 75% of the acid moiety of the E/X/Y copolymer is neutralized, preferably by a neutralizing agent comprising an alkali metal or an alkaline earth metal cation. For acid copolymers having a high acid level (for example over 15 wt %), the level of neutralization is preferably somewhat lower, to retain melt processibility.

Preferred cations useful in making the ionomers include, without limitation, lithium, sodium, potassium, magnesium, calcium, or zinc, or a combination of two or more of these cations.

The ionomer may optionally be combined with one or more organic acids. Suitable organic acids are aliphatic, mono-functional organic acids, particularly those having fewer than 36 carbon atoms. Particularly useful organic acids include, in increasing order of preference, C₄ to C₃₄, C₆ to C₂₆, C₆ to C₁₈, and C₆ to C₁₂ organic acids. The acids may be saturated, singly unsaturated, or multi-unsaturated. Also suitable are the salts of the organic acids, and combinations of organic acids and organic acid salts. The salts may include any of a wide variety of cations, preferably barium, lithium, sodium, zinc, bismuth, potassium, strontium, magnesium or calcium or a combination of two or more of these cations. Specific examples of organic acids useful in the present invention include caproic acid, caprylic acid, capric acid, lauric acid, stearic acid, behenic acid, erucic acid, oleic acid, and linoleic acid.

While it may be useful for the organic acids (and/or salts) to have a low volatility when being melt-blended with acid copolymer or ionomer, volatility has been found to not be limiting when neutralizing the blend to high levels, particularly near to or at 100%. At 100% neutralization (all acid in copolymer and organic acid neutralized), volatility simply is no longer an issue. Therefore, organic acids with lower carbon content can be used. It is preferred, however, that the organic acid (and/or salt) be non-volatile and non-migratory. By non-volatile, it is meant that they do not volatilize at temperatures of melt blending with the agent with the acid copolymer. By non-migratory, it is meant that the agent does not bloom to the surface of the polymer under normal storage conditions (ambient temperatures. Preferably, the organic acids (and/or salts) are agents that effectively plasticize ionic arrays and/or remove ethylene crystallinity from an ethylene, C₃₋₈ α,β-ethylenically unsaturated carboxylic acid copolymers or ionomers thereof.

When one or more organic acids are present in the thermoplastic material, they may be added to the polymer in acid form, in salt form, or as a mixture of acid(s) and salt(s). It will be apparent to those of skill in the art that, with the high temperatures and shear rates of extruder processing, or over longer time periods in milder conditions, there will be equilibration, to some extent, between the level of neutralization of the organic acid, and the level of neutralization of the ionomer. Thus, depending on the overall level of neutralization that is desired for the blend, it is possible to over neutralize the acid copolymer, and back titrate by adding the organic acid in its acid form. Conversely, it is possible to add the organic acid, completely neutralized, to an acid copolymer whose level of neutralization is below that which is desired for the blend of ionomer and organic acid. Also, the neutralization of the acid copolymer and that of the organic acid can each be adjusted, before blending, to be equal to the desired final level of the thermoplastic material. Those of skill in the art recognize that other permutations are possible, and are able to determine which methods may be desirable under particular circumstances. Those of skill in the art are also aware that a desired balance of cations can be achieved using similar principals and methods.

Preferred ionomeric compositions for use in the present invention also include soft and resilient ethylene copolymers, such as those that are described in U.S. application Ser. No. 10/108,793 and the applications that claim priority to it. Briefly, a soft, resilient thermoplastic material, when formed into a sphere that is 1.50 to 1.54 inches in diameter, has a coefficient of restitution (COR) of at least 0.785. The COR is measured by firing the sphere at an initial velocity of 125 feet/second against a steel plate positioned 3 feet from the point where initial velocity is determined and dividing the velocity of rebound from the plate by the initial velocity. In addition, the soft, resilient thermoplastic material has an Atti compression of no more than 100. Particularly preferred are materials with a COR of 0.790, 0.795, 0.800, 0.805, 0.810, 0.815, 0.820, 0.825, 0.830, 0.835, or greater and an Atti compression of 95, 90, 85, 80, 75 or lower. The specific combinations of resilience and compression used in the practice of the invention will in large part be dependent upon the type of golf ball desired (i.e., one-piece, two-piece, three-piece, or multi-layered), and in the type of performance desired for the resulting golf ball.

The present invention also provides an injection molding process for forming a thermoplastic golf ball comprising an ethylene acid copolymer ionomer, the process comprising the step of: injection molding an ethylene acid copolymer ionomer composition into a golf ball mold at a temperature of at least about 405° F. to about 550° F., wherein the conduit through which the ionomer is transported to the mold cavity is heated to maintain the ionomer at a temperature of at least about 405° F. to about 550° F.

The thermoplastic material may also contain one or more additives that are useful in golf balls. For example, one or more fillers may be included to impart additional density to blends of the previously described components, the selection being dependent upon the type of golf ball desired (i.e., one-piece, two-piece, three-piece or intermediate layer). Generally, the filler will be an inorganic material having a density greater than about 4 grams/cubic centimeter (g/cc), preferably greater than 5 g/cc, and will be present in amounts between 0 and about 60 wt % based on the total weight of the composition. Examples of useful fillers include zinc oxide, barium sulfate, lead silicate, tungsten carbide, tin oxide, and the like. It is preferred that the filler materials be non-reactive or substantially non-reactive. It is also preferred that the filler have little or no adverse effect on the physical properties of the thermoplastic material, for example that the filler not stiffen or raise the compression nor reduce the coefficient of restitution significantly.

Other optional additives useful in the practice of the invention include acid copolymer wax (e.g., Allied wax AC143 believed to be an ethylene/16-18% acrylic acid copolymer with a number average molecular weight of 2,040 D), which assists in preventing reaction between the filler materials (e.g., ZnO) and the acid moiety in the ethylene copolymer. Other optional additives include TiO₂, which is used as a whitening agent; optical brighteners; surfactants; processing aids; and the like.

Also provided are golf balls made according to the process of the invention. Included are one-piece golf balls and two-piece, three-piece, and multi-layer golf balls, if the ball, or its core, or its cover, or one or more of its intermediate layers or mantles, if any, has been made according to a process of the invention.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. An injection mold comprising two halves, each half comprising a manifold; a hemispherical mold cavity shaped to produce a golf ball or a portion of a golf ball when mated with the other half of the injection mold, said hemispherical mold cavity having a pole; a pin for holding a spherical portion of a golf ball; a conduit for conveying a molten thermoplastic material to the mold cavity; an inlet disposed at or near the pole for admitting molten thermoplastic material into the mold cavity; a valve gate for shutting off the flow of the molten thermoplastic material to the mold cavity; and a heat source to maintain the thermoplastic material at a processing temperature while it is in the conduit; wherein the two halves are connected by a flexible heated passage.

2. The injection mold of claim 1, wherein the conduit is a radius flow channel.

3. The injection mold of claim 1, wherein the heating source is one or more heaters positioned so that they do not cross over the conduit.

4. The injection mold of claim 1, wherein the mold cavity is cooled.

5. The injection mold of claim 4, wherein the mold cavity is cooled by a water jacket.

6. A process for injection molding a layer over a portion of a golf ball, comprising providing an injection mold of claim 1 and a portion of a golf ball; using the pins to secure the portion of a golf ball in a desired position in the mold cavity; conveying the molten thermoplastic material to the mold cavity through the conduit; using the heat source to maintain the thermoplastic material at the processing temperature while it is in the conduit; admitting the molten thermoplastic material into the mold cavity; and closing the valve gate to shut off the flow of the molten thermoplastic material to the mold cavity.

7. The process of claim 6, wherein the layer is an intermediate layer or mantle of a three-piece or multilayer golf ball.

8. The process of claim 6, wherein the layer is a cover of a golf ball.

9. The process of claim 6, wherein the thermoplastic material comprises an ionomer, and, optionally, an organic acid or the salt of an organic acid.

10. The process of claim 9, wherein the thermoplastic material has a coefficient of restitution of 0.790 or greater and an Atti compression of 95 or lower.

11. The process of claim 9, wherein the thermoplastic material further comprises one or more of a filler, an acid copolymer wax, a whitening agent, an optical brightener, a surfactants, or a processing aid.

12. A golf ball obtainable by the process of claim 6.

13. An injection molding process comprising the steps of forming a thermoplastic golf ball core and trimming excess polymer from the core, wherein the weight of excess polymer is less than 15% of the weight of the core.

14. The process of claim 13, wherein the weight of excess polymer is less than 5% of the weight of the core.

15. The process of claim 13, wherein the weight of excess polymer is less than 1% of the weight of the core.

16. A golf ball obtainable by the process of claim 13.

17. An injection molding process for forming a thermoplastic golf ball comprising the steps of: heating a thermoplastic material to a temperature above its melting point, and maintaining said temperature in the thermoplastic material until it is delivered to a golf ball mold.

18. A golf ball obtainable by the process of claim 17.

19. An injection molding process for forming a thermoplastic golf ball comprising an ethylene acid copolymer ionomer, the process comprising the step of: injection molding an ethylene acid copolymer ionomer composition into a golf ball mold at a temperature of at least about 405° F. to about 550° F., wherein the conduit through which the ionomer is transported to the mold comprises an external heat source to maintain the ionomer at a temperature of at least about 405° F. to about 550° F.

20. A golf ball obtainable by the process of claim 19.

21. A process for manufacturing a thermoplastic golf ball core or layer and minimizing polymer trim from the molded ball or portion of a ball using an injection molding apparatus comprising a manifold and polymer flow channels, the process comprising the steps: heating a thermoplastic polymer to a processing temperature at which it can flow through the polymer flow channels in the molding apparatus; providing heaters for the molding apparatus that heat the manifold and the polymer flow channels, wherein the heaters are placed such that they do not cross over the polymer flow channels; providing radius flow channels such that intersections of the polymer flow channels do not result in sharp turning angles having a definite corner; providing valve gates for polymer flow control to a mold; controlling the temperature of the manifold and flow channels to within a range of from 20° F. less than the polymer processing temperature to about 20° F. greater than the polymer processing temperature; providing the apparatus with flow channels that are sized such that the shear experienced by the thermoplastic polymer is less than or equal to 1000 sec⁻¹.

22. A golf ball obtainable by the process of claim 21.
